(19) United States
(12) Patent Application Publication
(10) Pub. No.: US 2026/0030777 A1
(43) Pub. Date: Jan. 29, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomoyori IWAO, Tokyo (JP)

(21) Appl. No.: 19/266,296

(22) Filed: Jul. 11, 2025

(30) Foreign Application Priority Data
Jul. 25, 2024 (JP) 2024-120380

(51) Int. Cl. G06T 7/73

(52) U.S. Cl. CPC G06T 7/73; G06T 2207/20081

(57) ABSTRACT

An image processing apparatus obtains images captured from multiple directions, sets, for each object, a three-dimensional space including the object as a learning space based on the images, and performs learning of, for each learning space, a corresponding three-dimensional field based on the captured images. In a case of learning the three-dimensional field corresponding to the learning space based on images captured synchronously at a given time point, for the learning space in which a still object is included, the image processing apparatus performs learning of a feature amount of the three-dimensional field corresponding to the learning space including a moving object by using a feature amount of the three-dimensional field already obtained as a result of learning based on the images captured synchronously at another time point as a feature amount of the three-dimensional field corresponding to the learning space.

### BACKGROUND

### Field

The present disclosure relates to an estimation technology for a three-dimensional field corresponding to a three-dimensional space of a subject.

### Description of the Related Art

There is a technology for estimating a three-dimensional field corresponding to a scene in a three-dimensional space of an imaging subject using data of a plurality of captured images (hereinafter referred to as “multi-viewpoint images”) obtained by capturing images from a plurality of mutually different viewpoints. In addition, there is a technology for generating, using an estimated three-dimensional field, an image (hereinafter referred to as a “virtual viewpoint image”) corresponding to an appearance of a scene from any virtual viewpoint. “NeRF: Representing Scene As Neural Radiance Fields For View Synthesis” discloses a technology for estimating a radiance field using a neural radiance field (NeRF) constituted by a neural network for deep learning as an example of a technology for estimating a three-dimensional field. By inputting virtual viewpoint information indicating a position of an arbitrary virtual viewpoint and a line-of-sight direction on the virtual viewpoint to a learned NeRF obtained as a result of NeRF training using a multi-viewpoint image, a virtual viewpoint image corresponding to an appearance of a scene from the virtual viewpoint is obtained. Specifically, by inputting virtual viewpoint information to a learned NeRF, a color and a volume density corresponding to the scene are estimated. The color and the volume density are integrated to obtain a pixel value of the virtual viewpoint image. Here, the volume density refers to an index representing opaqueness of a color.

In a case of performing learning of a NeRF, the following series of processing is repetitively executed. First, information indicating a position of an image capturing apparatus (hereinafter, referred to as an “image capturing position”) and an optical axis direction of the image capturing apparatus (hereinafter, referred to as an “orientation”) is input to the NeRF in the process of learning. Based on the input information, the NeRF executes processing similar to the processing to generate the virtual viewpoint image described above to generate an image corresponding to a captured image obtained by imaging performed by the image capturing apparatus. Next, using data of the captured image as training data, a weight parameter of the neural network constituting the NeRF is updated so that a difference between mutually corresponding pixel values of the image generated by the NeRF and the captured image decreases.

### SUMMARY

Learning as described above needs to be repetitively performed using a large amount of multi-viewpoint images in order to estimate a three-dimensional field such as a radiance field with high accuracy using a NeRF and the like. Therefore, the inventor realized that conventional estimation of a three-dimensional field has a problem in that the estimation requires a huge amount of computations.

An image processing apparatus according to the present disclosure includes: one or more hardware processors; and one or more memories storing one or more programs configured to be executed by the one or more hardware processors, the one or more programs including instructions for: obtaining a plurality of captured images obtained by synchronized image capturing of an image capturing space from a plurality of directions; setting, for each object existing in the image capturing space, a three-dimensional space including the object as a learning space based on the plurality of captured images; performing learning of, for each of the learning spaces set, a three-dimensional field corresponding to the learning space based on the plurality of captured images; and in a case of performing learning of the three-dimensional field corresponding to the learning space based on the plurality of captured images obtained by synchronized image capturing at a given time point, with respect to the learning space in which the object included in the learning space is a still object, performing learning of a feature amount of the three-dimensional field corresponding to the learning space including a moving object by using a feature amount of the three-dimensional field already obtained as a result of learning based on the plurality of captured images obtained by synchronized image capturing at another time point as a feature amount of the three-dimensional field corresponding to the learning space.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of an image capturing system according to embodiment 1;

FIG. 2 is a block diagram showing an example of a hardware configuration of an image processing apparatus according to embodiment 1;

FIGS. 3A and 3B are diagrams for describing an estimation method of a three-dimensional field of the image processing apparatus according to embodiment 1;

FIG. 4 is a block diagram showing an example of a functional configuration of the image processing apparatus according to embodiment 1;

FIG. 5 is a flow chart showing an example of a processing flow of the image processing apparatus according to embodiment 1;

FIGS. 6A to 6C are diagrams for describing an example of a feature amount according to embodiment 1;

FIG. 7 is a flow chart showing an example of a flow of learning processing by a learning unit according to embodiment 1;

FIGS. 8A and 8B are diagrams for describing an example of learning processing by the learning unit according to embodiment 1;

FIG. 9 is a flow chart showing an example of a processing flow of an image processing apparatus according to embodiment 2; and

FIG. 10 is a flow chart showing an example of a flow of learning processing by a learning unit according to embodiment 2.

### DESCRIPTION

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### Embodiment 1

Embodiment 1 describes an aspect in estimation of a three-dimensional field in which a still space in a scene is specified based on multi-viewpoint images obtained by synchronized image capturing at two mutually different time points and a three-dimensional field having already been estimated is appropriated for the specified still space.

Configuration of image capturing system

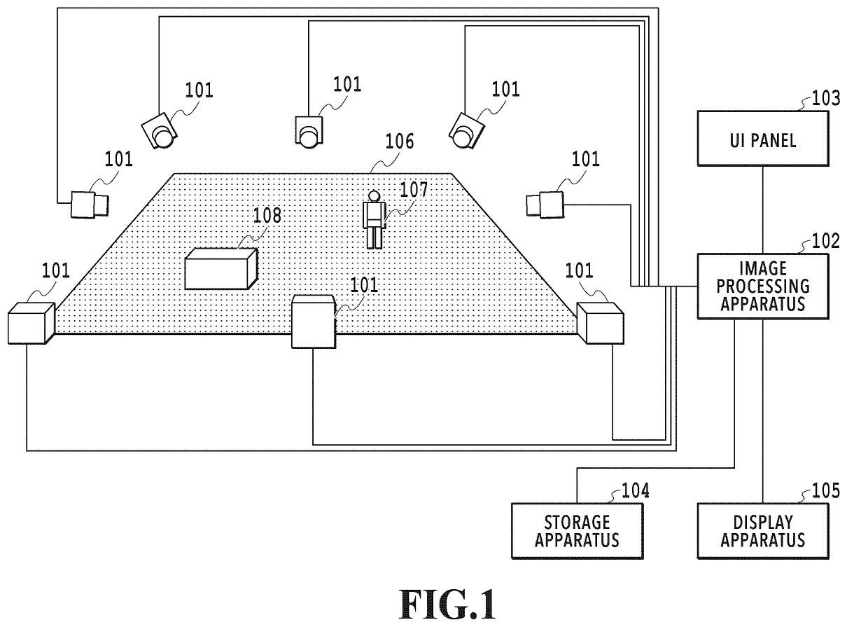

FIG. 1 is a diagram showing an example of a configuration of an image capturing system according to embodiment 1. The image capturing system includes a plurality of image capturing apparatuses 101, an image processing apparatus 102, a user interface (hereinafter, represented as “UI”) panel 103, a storage apparatus 104, and a display apparatus 105. Each of the image capturing apparatuses 101 is constituted of a digital still camera or a digital video camera, or the like and the image capturing apparatuses 101 are arranged at mutually different positions. The image capturing apparatuses 101 respectively perform, according to set image capturing conditions, synchronized image capturing of an object 107 and an object 108 that exist in an image capturing space 106 from mutually different viewpoints. Each image capturing apparatus 101 generates and outputs data of a captured image corresponding to each viewpoint according to the image capturing.

Note that mutually synchronized image capturing refers to image capturing by synchronous processing and also includes image capturing performed at approximately the same time point. Data of the captured image obtained as a result of the image capturing by the image capturing apparatus 101 may be data of a still image, data of a moving image, or data of both a still image and a moving image. Hereinafter, the term “image” will be described as including both a “still image” and a “moving image” unless otherwise noted. The data of the captured image generated by each image capturing apparatus 101 is transmitted to the image processing apparatus 102.

The image processing apparatus 102 obtains data of a plurality of captured images (multi-viewpoint images) transmitted from the plurality of image capturing apparatuses 101 and estimates a three-dimensional field corresponding to a three-dimensional space including the objects 107 and 108 that exist in the image capturing space 106 using the obtained multi-viewpoint images. Information on the three-dimensional field estimated by the image processing apparatus 102 is output to the storage apparatus 104. In addition, the image processing apparatus 102 generates a virtual viewpoint image based on the estimated three-dimensional field and a set virtual camera path. The virtual camera path refers to data including information indicating a position of a virtual viewpoint and a line-of-sight direction on the virtual viewpoint (hereinafter, referred to as a “virtual viewpoint direction”) in a time-series. The virtual viewpoint image generated by the image processing apparatus 102 is output to the storage apparatus 104, the display apparatus 105, or the like.

While each of the plurality of image capturing apparatuses 101 and the image processing apparatus 102 will be described as being connected to each other as shown in FIG. 1 in the present embodiment, a connection method between the image capturing apparatuses 101 and the image processing apparatus 102 is not limited thereto. Specifically, for example, the plurality of image capturing apparatuses 101 may be cascaded by connecting mutually adjacent image capturing apparatuses 101 to each other and at least one of the plurality of image capturing apparatuses 101 may be connected to the image processing apparatus 102.

The UI panel 103 includes a display device such as a liquid crystal panel and displays, on the display device, a GUI (graphical user interface) for presenting a user with information such as image capturing conditions in the image capturing apparatuses 101 and processing settings of the image processing apparatus 102. In addition, the UI panel 103 may include an input device such as a touch panel or buttons and, in this case, the UI panel 103 accepts instructions from the user related to setting or changing the image capturing conditions or the processing conditions described above via the input device. Furthermore, the UI panel 103 may accept an instruction from the user related to setting a virtual viewpoint in a case of generating a virtual viewpoint image based on the estimated three-dimensional field. Note that the user need not necessarily perform input from the input device included in the UI panel and, for example, the user may perform input using an input device such as a mouse or a keyboard connected to the UI panel 103, the image processing apparatus 102, or the like.

The storage apparatus 104 is constituted of a hard disk drive or the like and stores data of captured images obtained by synchronized image capturing by each image capturing apparatus 101 and information related to an estimated three-dimensional field related to the objects 107 and 108 output from the image processing apparatus 102. In addition, the storage apparatus 104 may store data of the virtual viewpoint image output from the image processing apparatus 102. The display apparatus 105 is constituted of a liquid crystal display or the like and displays the virtual viewpoint image generated and output by the image processing apparatus 102 based on the estimated three-dimensional field and the set virtual camera path.

### Hardware Configuration of Image Processing Apparatus

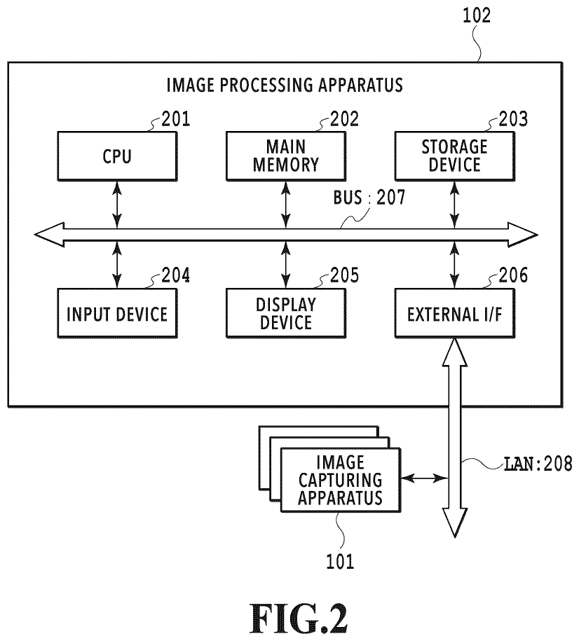

FIG. 2 is a block diagram showing an example of a hardware configuration of the image processing apparatus 102 according to embodiment 1. As hardware components, the image processing apparatus 102 includes a CPU 201, a main memory 202, a storage device 203, an input device 204, a display device 205, and an external I/F 206. The respective units included in the image processing apparatus 102 as hardware components are connected via a bus 207 to be capable of communicating with each other.

The CPU 201 is an arithmetic processing apparatus that comprehensively controls the image processing apparatus 102 and performs various kinds of processing by executing various programs stored in the storage device 203 or the like. The main memory 202 temporarily stores data, parameters, and the like used in various kinds of processing and is also used as a work area of the CPU 201. The storage device 203 is a mass storage apparatus that stores various kinds of data and the like necessary for displaying various kinds of programs and GUIs (graphical user interfaces). For example, the storage device 203 is constituted of a non-volatile memory such as a hard disk drive or a silicon disk drive. Note that processing of each step shown in the flow charts to be described later is realized by a program code stored in the storage device 203 or the like being deployed in the main memory 202 and executed by the CPU 201.

The input device 204 is constituted of a keyboard, a mouse, an electronic pen, a touch panel, or the like and accepts operation input from the user. The display device 205 is constituted of a liquid crystal panel or the like and performs display of a GUI or the like. The external I/F 206 is an interface for communicating with external apparatuses such as each image capturing apparatus 101. For example, the image processing apparatus 102 and each image capturing apparatus 101 are connected via the external I/F 206 and a LAN (local area network) 208 and transmission and reception of data of captured images, data of control signals, and the like are performed via the external I/F 206 and the LAN 208. The LAN 208 is not limited to a local area network and may be constituted of an SDI (Serial Digital Interface), an HDMI (R) (High-Definition Multimedia Interface (R)), or the like.

Based on a control signal output from the image processing apparatus 102, each image capturing apparatus 101 starts and stops image capturing, changes settings of image capturing conditions related to shutter speed, aperture, or the like, and outputs data of captured images obtained by image capturing. Note that while the image processing apparatus 102 may include various components other than the hardware configuration described above, other hardware configurations are not the main focus of the present disclosure and a description thereof will be omitted.

Hereinafter, assuming that estimation of a three-dimensional field is to be performed by learning a learning model that models the three-dimensional field in the image capturing space 106 (hereinafter, referred to as a “three-dimensional field model”), a learning method of the three-dimensional field model will be described. In addition, while the three-dimensional field model will be described as being a NeRF constructed by a multilayer perceptron and the three-dimensional field will be described as being represented by radiance fields as one example in the present embodiment, a configuration of the three-dimensional field model and the three-dimensional field are not limited thereto.

A representation method of a three-dimensional field differs depending on learning contents. Specifically, for example, the three-dimensional field model may be constructed by InstantNGP that is a high-speed method similar to NeRF. In addition, the three-dimensional field model is not limited to a three-dimensional field model constructed by a multilayer perceptron and may be constructed by Plenoxels or TensoRF (Tensorial Radiance Fields) or the like which explicitly represents a three-dimensional field. Alternatively, the three-dimensional field model may be constructed by NeuS or the like of which accuracy of shape estimation is improved due to representation of a three-dimensional field by SDF (Signed Distance Field). Alternatively, the three-dimensional field model may be constructed by various methods such as a three-dimensional field model constructed by 3D Gaussian Splatting or the like in which a three-dimensional field is expressed by a set of dots with a spread. <Overview of estimation method of three-dimensional field >

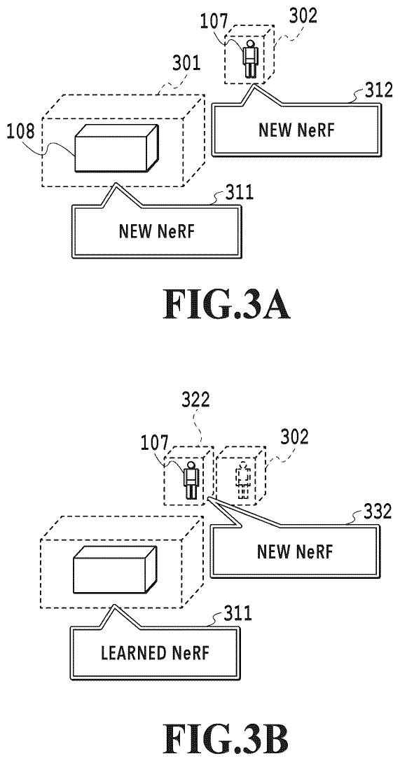

FIGS. 3A and 3B are diagrams for describing an estimation method of a three-dimensional field in the image processing apparatus 102 according to embodiment 1. Specifically, FIG. 3A shows an example of an estimation method of radiance fields in a reference frame and FIG. 3B shows an example of an estimation method of radiance fields in a new frame. An overview of an estimation method of radiance fields in the image processing apparatus 102 will be described with reference to FIGS. 3A and 3B.

Here, a reference frame refers to a plurality of captured images (multi-viewpoint images) obtained by synchronized image capturing at a time point to be a reference (hereinafter, referred to as a “reference time point”) in each of the image capturing apparatuses 101. For example, in a case where the captured images are moving images, the reference frame is to be a multi-viewpoint image constituted of a plurality of frames obtained by synchronized image capturing at the reference time point in each of the image capturing apparatuses 101. In addition, the radiance fields in the reference frame refers to radiance fields estimated at the reference time point which is obtained as a result of learning using the reference frame. Furthermore, a new frame refers to a plurality of captured images (multi-viewpoint images) obtained by synchronized image capturing at a time point that differs from the reference time point (hereinafter, referred to as a “new time point”) in each of the image capturing apparatuses 101. For example, in a case where the captured images are moving images, the new frame is, similar to the reference frame, to be a multi-viewpoint image constituted of a plurality of frames obtained by synchronized image capturing at the new time point in each of the image capturing apparatuses 101. In addition, the radiance fields in the new frame refers to radiance fields estimated at the new time point which is obtained as a result of learning using at least the new frame.

An overview of an estimation method of radiance fields at the reference time point will be described with reference to FIG. 3A. At the reference time point, the image processing apparatus 102 sets learning spaces 301 and 302 with respect to a three-dimensional space that includes each of the object 107 and the object 108 in the image capturing space 106. For example, first, the image processing apparatus 102 uses the reference frame to specify a three-dimensional space (hereinafter, referred to as an “object space”) that includes each object by obtaining position coordinates of the three-dimensional space in which each of the objects 107 and 108 exists. Next, the image processing apparatus 102 sets spaces containing each of the one or more specified object spaces as learning spaces 301 and 302. Details of a method of obtaining position coordinates of the three-dimensional space in which each of the objects 107 and 108 exists will be described later.

Next, the image processing apparatus 102 assigns new NeRFs 311 and 312 prior to learning to the respective learning spaces 301 and 302. Hereinafter, a description will be given on the assumption that the NeRF 311 is assigned to the learning space 301 and the NeRF 312 is assigned to the learning space 302. Next, using the reference frame, the image processing apparatus 102 performs learning of the NeRFs 311 and 312 assigned to the learning spaces 301 and 302. As a result of the learning, the learned NeRF 311 is obtained as an estimation result of radiance fields corresponding to the learning space 301 and the learned NeRF 312 is obtained as an estimation result of radiance fields corresponding to the learning space 302.

An overview of an estimation method of radiance fields at the new time point will be described with reference to FIG. 3B. At the new time point, the image processing apparatus 102 judges whether or not each of the objects 107 and 108 keeps a still state with respect to the reference time point. Hereinafter, a description will be given on the assumption that the object 108 included in the learning space 301 keeps a still state but the object 107 included in the learning space 302 does not keep a still state and has moved.

Next, the image processing apparatus 102 assigns the learned NeRF 311 obtained as a result of learning using the reference frame to the learning space 301 that includes the object (hereinafter, referred to as a “still object”) that keeps a still state. On the other hand, the image processing apparatus 102 sets a new learning space 322 that contains the three-dimensional space in which the moved object (hereinafter, referred to as a “moving object”) 107 exists and assigns the new NeRF 332 prior to learning to the new learning space 322. The image processing apparatus 102 fixes the weight parameter of the three-dimensional field model without performing relearning with respect to the learned NeRF 311 and performs learning only with respect to the new NeRF 332. As a result of the learning, the learned NeRF 332 is obtained as an estimation result of radiance fields corresponding to the learning space 322 at the new time point.

In this manner, a learning result of a NeRF assigned to a learning space including a still object at the reference time point or, in other words, an estimation result of radiance fields corresponding to the learning space is appropriated as an estimation result of radiance fields corresponding to the learning space at the new time point. Therefore, according to such a learning method, a part of learning processing in the estimation of radiance fields at the new time point may be reduced and, as a result, an amount of computations required to estimate radiance fields at the new time point may be reduced.

### Functional Configuration of Image Processing Apparatus

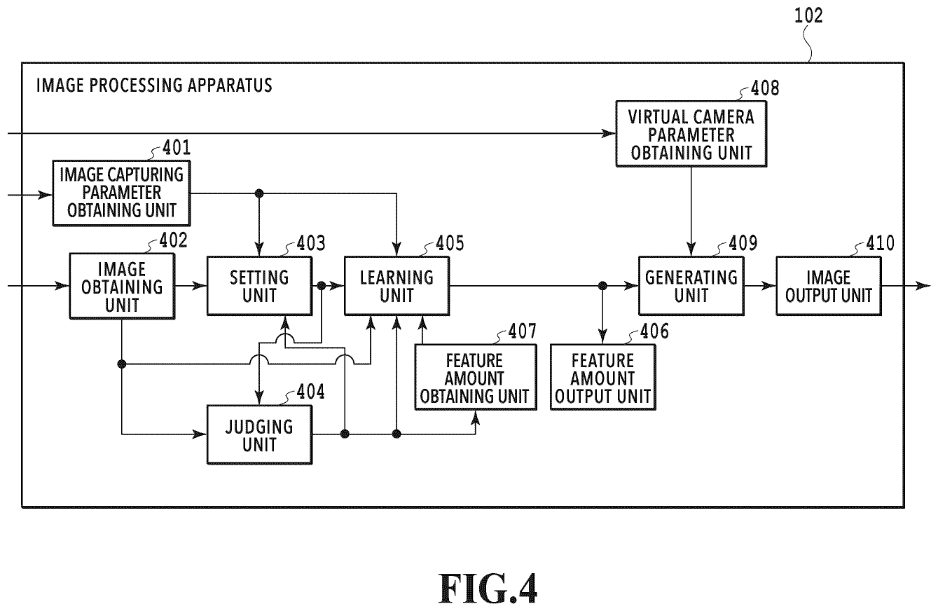

FIG. 4 is a block diagram showing an example of a functional configuration of the image processing apparatus 102 according to embodiment 1. As functional components, the image processing apparatus 102 includes an image capturing parameter obtaining unit 401, an image obtaining unit 402, a setting unit 403, a judging unit 404, a learning unit 405, a feature amount output unit 406, and a feature amount obtaining unit 407. Furthermore, in addition to the functional components described above, the image processing apparatus 102 includes a virtual camera parameter obtaining unit 408, a generating unit 409, and an image output unit 410. Each unit included in the image processing apparatus 102 as a functional component is realized by the CPU 201 executing a program stored in the storage device 203 or the like using the main memory 202 as a work area. Note that not all processing steps described below need necessarily be realized by the execution of a program by the CPU 201 and the image processing apparatus 102 may be configured so that a part of or all of the processing steps are executed by one or a plurality of processing circuits other than the CPU 201. The image obtaining unit 402 obtains data of the multi-viewpoint image obtained by synchronized image capturing by each image capturing apparatus 101. Learning of a NeRF that is an example of a three-dimensional field model is performed using the multi-viewpoint image obtained by the image obtaining unit 402.

The image capturing parameter obtaining unit 401 obtains image capturing parameters of each image capturing apparatus 101. The image capturing parameters include an external parameter, an internal parameter, and a distortion parameter. An external parameter refers to a parameter that represents a position and an orientation of the image capturing apparatus. An internal parameter refers to a parameter that represents coordinates of a center of a captured image obtained by image capturing by the image capturing apparatus and a focal length of a lens included in the image capturing apparatus. A distortion parameter refers to a parameter that indicates a distortion of the lens. The image capturing parameters of each image capturing apparatus 101 may be calculated from a result of a camera calibration performed in advance. Hereinafter, a description will be given on the assumption that the image capturing parameters of each image capturing apparatus 101 are stored in the storage device 203 in advance and that the image capturing parameter obtaining unit 401 obtains the image capturing parameters of each image capturing apparatus 101 by reading the image capturing parameters from the storage device 203. Note that the image capturing parameter obtaining unit 401 may calculate and obtain the image capturing parameters of each image capturing apparatus 101 by performing a camera calibration using a multi-viewpoint image obtained by the image obtaining unit 402.

The setting unit 403 sets a learning space of a NeRF for each of the objects 107 and 108 based on the multi-viewpoint image obtained by the image obtaining unit 402. In addition, based on a judgment result by the judging unit 404, the setting unit 403 assigns a feature amount of a new NeRF or a learned NeRF to the learning space. With respect to each learning space set for each of the objects 107 and 108 by the setting unit 403, the judging unit 404 judges whether or not the learning space is a learning space that includes a still object based on the multi-viewpoint image obtained by the image obtaining unit 402. The setting unit 403 assigns the feature amount of the learned NeRF with respect to a learning space judged to be a learning space including a still object by the judging unit 404. On the other hand, the setting unit 403 assigns a new NeRF with respect to a learning space judged to be a learning space not including a still object or, in other words, a learning space including a moving object.

The learning unit 405 estimates radiance fields corresponding to a three-dimensional space including the objects 107 and 108 by performing learning of the new NeRF assigned to the learning space by the setting unit 403. In a case where radiance fields are estimated based on the reference frame, a learned NeRF does not yet exist. Therefore, after the end of learning based on the reference frame by the learning unit 405, the feature amount output unit 406 outputs the feature amount of the learned NeRF to the storage apparatus 104 or the like and causes the storage apparatus 104 or the like to store the feature amount.

In addition, in a case where the radiance fields are estimated based on a new frame, the feature amount of the learned NeRF is already stored in the storage apparatus 104 or the like as an estimation result of radiance fields based on the reference frame. The feature amount obtaining unit 407 obtains the feature amount of the learned NeRF stored in the storage apparatus 104 or the like based on the judgment result by the judging unit 404. The feature amount of the learned NeRF obtained by the feature amount obtaining unit 407 is assigned to the learning space including the still object by the setting unit 403. The learning unit 405 estimates radiance fields corresponding to the learning space by performing learning with respect to the new NeRF assigned to the learning space using a new frame and the feature amount of the learned NeRF having been assigned to the learning space.

The virtual camera parameter obtaining unit 408 obtains a virtual camera path. The generating unit 409 generates a virtual viewpoint image corresponding to an appearance from a virtual viewpoint based on a result of learning by the learning unit 405 and the obtained estimated radiance fields or, in other words, the learned radiance fields and the virtual camera path obtained by the virtual camera parameter obtaining unit 408. Specifically, in a case of generating a virtual viewpoint image, volume rendering to be described later is performed with respect to each of a plurality of rays from the virtual viewpoint. The virtual viewpoint image generated by the generating unit 409 is output to and displayed by the UI panel 103, the display apparatus 105, or the like.

The generating unit 409 may output a feature amount calculated for each ray in volume rendering in a case of generating a virtual viewpoint image corresponding to a reference frame to the storage apparatus 104 or the like and cause the storage apparatus 104 or the like to store the feature amount. In this case, in a case of generating a virtual viewpoint image corresponding to a new frame, the generating unit 409 may generate a virtual viewpoint image with respect to a learning space including a still object using the feature amount stored in the storage apparatus 104 or the like based on the judgment result by the judging unit 404. Note that with respect to a learning space including a moving object, the generating unit 409 does not use the feature amount stored in the storage apparatus 104 or the like and performs volume rendering using a learning result of a new NeRF based on the new frame by the learning unit 405.

### Operation of Image Processing Apparatus

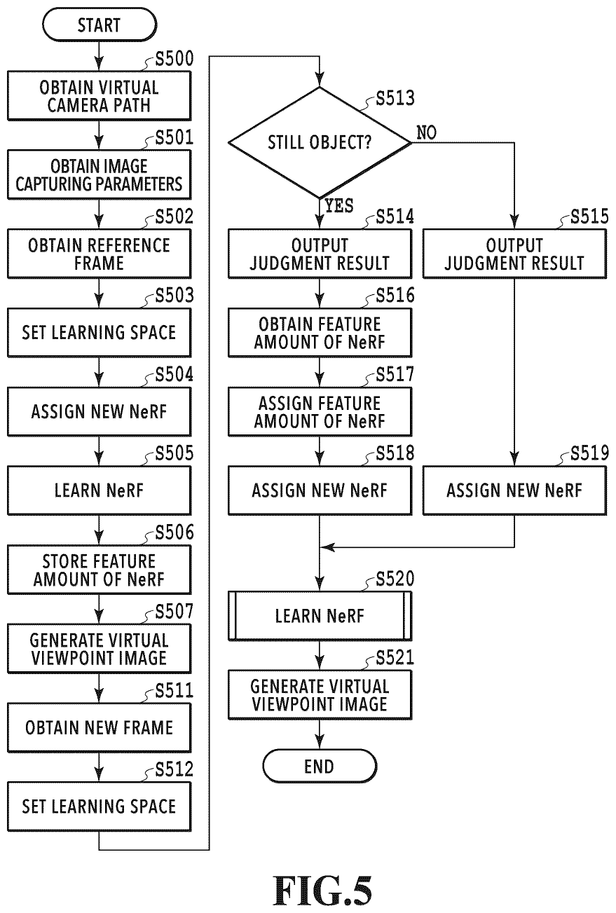

FIG. 5 is a flow chart showing an example of a processing flow of the image processing apparatus 102 according to embodiment 1. A series of processing steps shown in the flow chart in FIG. 5 is realized by the CPU 201 reading a predetermined program from the storage device 203, deploying the program on the main memory 202, and executing the program. First, in S500, the virtual camera parameter obtaining unit 408 obtains a virtual camera path. Note that the obtaining processing of the virtual camera path may be executed at any timing as long as the obtaining processing precedes generation processing of a virtual viewpoint image in S507 to be described later. Next, in S501, the image capturing parameter obtaining unit 401 obtains image capturing parameters of each image capturing apparatus 101. Hereinafter, a description will be given on the assumption that the image capturing parameters of each image capturing apparatus 101 do not change over time during the operation of the image processing apparatus 102. Note that the obtaining processing of the image capturing parameters may be executed at any timing as long as the obtaining processing precedes setting processing of a learning space in S503 to be described later.

Next, in S502, the image obtaining unit 402 obtains data of the multi-viewpoint image (reference frame) obtained by synchronized image capturing by each image capturing apparatus 101 at the reference time point. Specifically, data of the reference frame output from the plurality of image capturing apparatuses 101 is temporarily stored in the main memory 202 via the LAN 208, the external I/F 206, and the bus 207. Here, the reference time point refers to, for example, a time point corresponding to a start frame of a scene for generating the virtual viewpoint image. The reference time point is not limited thereto and may be, for example, a time point in a state where the moving object does not exist which precedes the time point corresponding to the start frame of the scene for generating the virtual viewpoint image.

Next, in S503, the setting unit 403 sets a three-dimensional space including an object as a learning space of a NeRF based on the image capturing parameters obtained in S501 and the reference frame obtained in S502. Specifically, the setting unit 403 specifies a three-dimensional space including an object for each object based on the image capturing parameters and the reference frame and sets a space containing each of the three-dimensional spaces specified for each object as the learning space of a NeRF.

For example, the setting unit 403 estimates a three-dimensional shape of each object based on the image capturing parameters and the reference frame and, for each estimated three-dimensional shape of an object, sets a rectangular parallelopiped that circumscribes the three-dimensional shape as a learning space. In this case, with respect to the rectangular parallelopiped that circumscribes the three-dimensional shape, a size of the learning space may be set larger than a circumscribed shape by a predetermined size such as setting the learning space one size larger than the size of the rectangular parallelopiped that circumscribes the three-dimensional shape. By setting a larger learning space in this manner, a possibility of occurrence of so-called artifacts may be reduced. As an estimation method of a three-dimensional shape of an object, for example, there is a VH (visual hull) method. In the VH method, an area including a representation of an object is extracted as a silhouette area from each captured image that constitutes a multi-viewpoint image and a three-dimensional shape of the object is obtained from the extracted silhouette area and the image capturing parameters used in a case of capturing the captured image. Extraction methods of the silhouette area of an object include a background difference method in which a difference between a background image obtained in advance and a captured image is obtained and a method of performing segmentation processing with respect to the captured image. Note that image capturing parameters have already been obtained by the image capturing parameter obtaining unit 401 in S501. The setting unit 403 projects the silhouette area of the object in each captured image onto a three-dimensional space based on corresponding image capturing parameters and obtains a product set of projected areas as the three-dimensional shape of the object.

Specifically, first, the setting unit 403 defines a three-dimensional space with voxels of a given size laid out. Next, with respect to all voxels in the three-dimensional space, the setting unit 403 projects each voxel from three-dimensional coordinates onto each of two-dimensional captured images that constitute the multi-view image. Next, the setting unit 403 judges whether or not each projected voxel overlaps with the silhouette area of the object in each captured image. Next, the setting unit 403 determines a voxel of which the number of captured images judged as overlapping captured images equals or exceeds a given threshold as a voxel that constitutes a part of the three-dimensional shape of the object. For example, the setting unit 403 gives “0” indicating an OFF voxel to flags of all of the voxels as an initial value. The setting unit 403 changes the value of the flag of a voxel determined to be a voxel that constitutes a part of the three-dimensional shape of the object to “1” indicating an ON voxel. A set of voxels (ON voxels) of which the flag value is set to “1” becomes a voxel group that constitutes the three-dimensional shape of the object.

While a description of estimating the three-dimensional shape of an object using the VH method will be given in the present embodiment, the estimation method of the three-dimensional shape of an object is not necessarily limited to the VH method. For example, the three-dimensional shape of an object may be estimated based on a small number of captured images obtained by image capturing by one or more image capturing apparatuses 101 using a learned model obtained as a result of learning by deep learning. Alternatively, the three-dimensional shape of an object may be estimated by specifying a position of a surface of an object in a three-dimensional space as a point cloud using a ranging apparatus using LiDAR or the like.

After S503, in S504, the setting unit 403 assigns a new NeRF to each learning space set for each object in S503. Next, in S505, the learning unit 405 performs learning of the new NeRF assigned to each learning space in S504. Specifically, as described earlier in Description of the Related Art, the learning unit 405 performs learning of the new NeRF assigned to each learning space using a multi-viewpoint image.

A general learning method of NeRF will be described. NeRF estimates a corresponding color c and a volume density o (volumetric scene density) in response to input of an arbitrary position (x, y, z) in a learning space and a line-of-sight direction (θ, Q) with respect to the position in a learning space. Specifically, first, in NeRF, a ray corresponding to a direction from an image capturing position to each pixel of a captured image is set. Next, a plurality of sampling points are set on the set ray. Next, the color c and the volume density o at each set sampling point are estimated. Next, by integrating the estimated color c and estimated density o at each sampling point on the same ray from the image capturing position, a value of pixels corresponding to each ray (pixel value) is determined and an image corresponding to the captured image is generated. The generation of such images is commonly referred to as volume rendering. Next, the weight parameter of the neural network is updated so that a difference between an image generated by volume rendering and a captured image as correct answer data that corresponds to the image is reduced.

In the present embodiment, since a NeRF is assigned to each learning space corresponding to each object, two or more learning spaces may exist in an image capturing space and, accordingly, two or more NeRFs may be assigned to the image capturing space. In a case where two or more NeRFs are assigned to the image capturing space, the integration processing described above is performed to generate an image by the number of learning spaces in which rays intersect each other.

For example, in a case where a ray corresponding to a given pixel sequentially passes through the learning space 301 and the learning space 302, a plurality of sampling points are generated in the learning space 301 and in the learning space 302 by NeRFs respectively assigned to the learning spaces. Next, the color and the density at each sampling point in each of the learning spaces 301 and 302 are estimated by the NeRF assigned to each learning space. Next, volume rendering is performed by sequentially integrating the color and the density of respective sampling points estimated in the learning space 301 and the learning space 302 and an image is generated. Details of the learning method of each NeRF and the volume rendering method in a case where two or more NeRFs are assigned to the image capturing space are described in “DeRF: Decomposed Radiance Fields”. Since the methods are not the main focus of the present disclosure, a detailed description of the methods will be omitted.

After the learning processing of each NeRF in S505 ends, in S506, the feature amount output unit 406 outputs a feature amount of each NeRF obtained as a result of the learning processing in S505 to the storage apparatus 104 or the like and causes the storage apparatus 104 or the like to store the feature amount. Here, an end condition of the learning processing of each NeRF in S505 is, for example, in a case where a difference between a captured image as correct answer data and an image generated by volume rendering corresponding to the captured image becomes smaller than a given threshold. Note that the end condition is not limited thereto and, for example, the end condition may be in a case where a number of performances of supervised learning using each captured image as correct answer data reaches a given number of performances, in a case where learning processing has been performed over a given period, or the like.

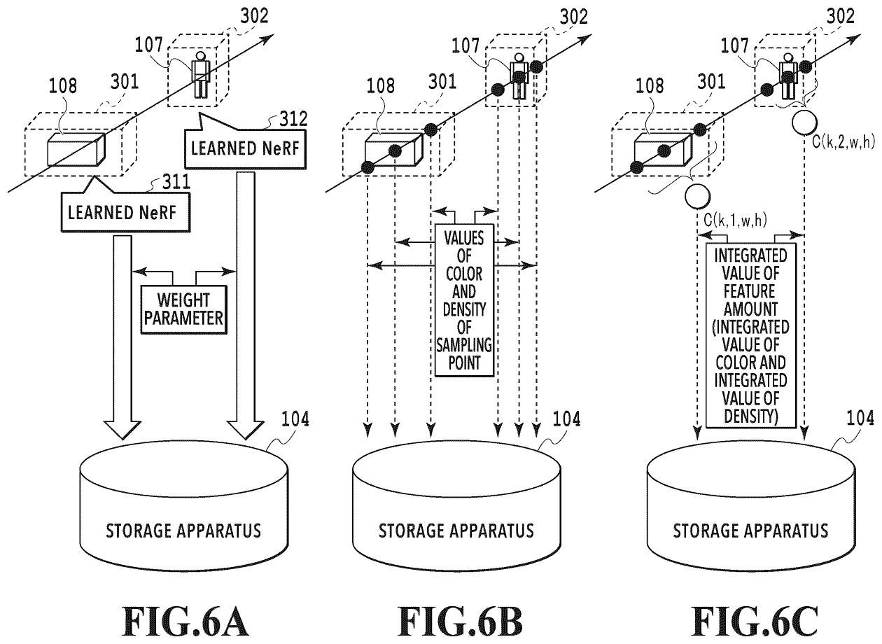

FIGS. 6A to 6C are diagrams for describing an example of a feature amount of NeRFs according to embodiment 1. The feature amount of NeRFs is, for example, a weight parameter of each of the NeRFs 311 and 312 as shown as one example in FIG. 6A. The feature amount of a NeRF may be values of the color c and the density o estimated as a result of learning at each sampling point set to each of the learning spaces 301 and 302 as shown as one example in FIG. 6B. Let k denote an image capturing position, (w, h) denote a pixel position in a captured image, and r denote an identifier such as a number that may uniquely identify a NeRF, then each of the feature amounts expressed by the values of color c and density o may be expressed as c (k, r, w, h) and σ (k, r, w, h), in turn. Causing the storage apparatus 104 or the like to store such feature amounts eliminates the need to derive feature amounts of learning spaces including a still object in the subsequent learning processing of a NeRF.

In addition, as shown as one example in FIG. 6C, the feature amount of a NeRF may be a value integrated from an image capturing position with respect to each of the color c and the density σ estimated at each sampling point on the same ray and in the same learning space. A feature amount C that is expressed by an integrated value of color and an integrated value of density may be calculated using, for example, equations (1) and (2) below.

$$C ( k , r , w , h ) = {\sum }_{i = 1}^{N} {T}_{i} ( k , r , w , h ) ( 1 - exp ( - {σ}_{i} ( k , r , w , h ) {δ}_{i} ) ) \qquad equation ( 1 )$$

$${T}_{i} ( k , r , w , h ) = exp ( - {\sum }_{j = 1}^{i = 1} {σ}_{i} ( k , r , w , h ) {δ}_{i} ) \qquad equation ( 2 )$$

Here, Tᵢ denotes accumulated transmittance at each sampling point. In addition, in a similar manner to above, k denotes an image capturing position, (w, h) denotes a pixel position in a captured image, and r denotes an identifier of a NeRF. Furthermore, N denotes a total number of sampling points, and di denotes a distance from an i-th sampling point i to a next i+1-th sampling point i+1.

In addition, the integrated value of density in the feature amount of a NeRF may be expressed using an integrated value W of weight obtained by converting the density into a weight w. The integrated value W of weight may be calculated using, for example, using equations (3) and (4) below.

$$W ( k , r , w , h ) = {\sum }_{i = 1}^{N} {w}_{i} ( k , r , w , h ) \qquad equation ( 3 )$$

$${w}_{i} ( k , r , w , h ) = {T}_{i} ( k , r , w , h ) ( 1 - exp ( - {σ}_{i} ( k , r , w , h ) {δ}_{i} ) \qquad equation ( 4 )$$

In addition to the values of the color c and the density o estimated at each sampling point, the feature amount of a NeRF may also include various feature amounts such as a value obtained by integrating each of the color and the density at each sampling point set on the same ray and in the same learning space.

After S506, in S507, the generating unit 409 generates a virtual viewpoint image based on a learned NeRF corresponding to each learning space obtained as a result of the learning processing in S505 or, in other words, the estimated radiance field and the virtual camera path obtained in S500. As a generation method of the virtual viewpoint image, the method of volume rendering described above in the description of S505 may be used.

After S507, in S511, the image obtaining unit 402 obtains data of the multi-viewpoint image (new frame) obtained by synchronized image capturing by each image capturing apparatus 101 at the new time point. Specifically, data of the new frame output from the plurality of image capturing apparatuses 101 is temporarily stored in the main memory 202 via the LAN 208, the external I/F 206, and the bus 207. Here, the new frame is a multi-viewpoint image which is obtained by synchronized image capturing by each image capturing apparatus 101 at a time point after the reference time point and which is captured in a synchronized manner at a time point that differs from the reference frame.

Next, in S512, the setting unit 403 sets a three-dimensional space including an object as a learning space of a NeRF based on the image capturing parameters obtained in S501 and the new frame obtained in S511. Specifically, the setting unit 403 specifies a three-dimensional space including an object for each object based on the image capturing parameters and the new frame and sets a space containing each of the three-dimensional spaces specified for each object as the learning space of a NeRF. Since the setting processing of the learning space based on the new frame in S512 is similar to the setting processing of the learning space based on the reference frame in S503, a detailed description will be omitted.

Next, in S513, for each learning space set so as to include each object, the judging unit 404 judges whether or not the object included in each learning space is a still object. In a case where it is judged in S513 that an object included in at least one learning space is a still object, the judging unit 404 executes processing of S514. In this case, in S514, the judging unit 404 outputs information indicating that the feature amount of the NeRF stored in the storage apparatus 104 or the like is to be used for the learning space, to the learning unit 405, the setting unit 403, and the feature amount obtaining unit 407 as a judgment result of the learning space. In a case where it is judged in S513 that the object included in all of the learning spaces is not a still object or, in other words, the object is a moving object, the judging unit 404 executes processing of S515. In this case, in S515, the judging unit 404 outputs information indicating that learning is to be performed by assigning a new NeRF to the learning space instead of using the feature amount of the NeRF stored in the storage apparatus 104 or the like for the learning space as a judgment result of the learning space. Specifically, the judging unit 404 outputs the judgment result of the learning space to the learning unit 405 and the setting unit 403.

As a method of judging whether or not an object is a still object, for example, there is a method of judging based on an amount of movement of a three-dimensional shape of the object as estimated according to the VH method. Let V_{Fs} denote a vertex cloud of a three-dimensional shape included in a given learning space di set based on a reference frame Fs. In addition, let V_{Fp} denote a vertex cloud of the three-dimensional shape included in the learning space di set based on a new frame Fp. For example, the judging unit 404 calculates an amount of movement from a reference time point to a new time point of the vertex cloud of the three-dimensional shape included in the same learning space di. Next, for example, as shown in equation (5), in a case where the calculated amount of movement is larger than a given threshold Vₜₕ, the judging unit 404 judges that the learning space di is a learning space that does not include a still object or, in other words, a learning space that includes a moving object. On the other hand, in a case where the calculated amount of movement is equal to or smaller than the threshold Vth, the judging unit 404 judges that the learning space di is a learning space that includes a still object. Note that each vertex of the three-dimensional shape of the object in the reference frame Fs and the new frame Fp may be mapped to each other by vertex tracking, search processing of a nearest neighbor vertex, or the like.

$$‖ {V}_{Fs} - {V}_{Fp} ‖ > {V}_{th} \qquad equation ( 5 )$$

In a case where the three-dimensional shape included in the learning space di has a plane, the judging unit 404 may also calculate an amount of movement of the place in a similar manner to vertexes and judge whether or not the learning space di is a learning space including a still object using the calculated amount of movement of the plane. The amounts of movement described above are referred to as an inter-shape distance and are commonly referred to as a Hausdorff distance or a Chamfer distance. Furthermore, the judging unit 404 may obtain the amount of movement of the three-dimensional shape using a general tracking method of a three-dimensional shape.

The judging unit 404 may also use, for the judgment, a position, a shape, or the like of a silhouette area of an object in each captured image used in the estimation of a three-dimensional shape in the VH method. Specifically, first, the judging unit 404 labels a silhouette region corresponding to the object included in each learning space in each captured image. Next, the judging unit 404 acquires an amount of movement from the reference time point to the new time point in the captured image of the labeled silhouette region and judges an object corresponding to the silhouette region of which the amount of movement is equal to or larger than a given threshold to be a moving object. Methods such as optical flow may be used to calculate the amount of movement. In a case where a still object is determined in advance in a given scene, the user may tag the still object before estimating a radiance field to designate the still object and a learning space including the still object in advance.

Note that in a case where the numbers of learning spaces set by the setting unit 403 based on the reference frame and the new frame differ from each other, the judging unit 404 executes processing described below. Specifically, in this case, first, the judging unit 404 associates one or more learning spaces set based on the reference frame with one or more learning spaces set based on the new frame. For example, the judging unit 404 associates, with each other, learning spaces of which positions, shapes, sizes, or the like are closest to each other. Next, with respect to the learning spaces associated with each other, for each pair of the learning spaces, the judging unit 404 judges whether or not the learning spaces include a still object using the judgment method described above. Note that with respect to a learning space without a corresponding learning space, the judging unit 404 judges that, for example, the learning space includes a moving object.

After S514, in S516, based on the judgment result of the learning space output in S514, the feature amount obtaining unit 407 obtains a feature amount of a NeRF corresponding to the learning space judged to include a still object in S513 from the storage apparatus 104 or the like. Next, in S517, the setting unit 403 assigns the feature amount of the NeRF obtained in S516 or, in other words, a learned NeRF, values of the color and the density at a sampling point on a ray, or an integrated value thereof to the learning space judged to include a still object in S513. This is because a radiance field corresponding to the learning space including the still object has already been estimated based on the reference frame and there is no need to assign a new NeRF to the learning space including the still object to perform learning once again. Next, in S518, the setting unit 403 assigns a new NeRF to each of all learning spaces judged not to include a still object or, in other words, judged to include a moving object in S513.

On the other hand, after S515, in S519, based on the judgment result of the learning space output in S515, the setting unit 403 assigns a new NeRF to each of all learning spaces judged not to include a still object or, in other words, judged to include a moving object in S513. Note that “0” or a random value generated by a random number generator or the like is given to the weight of each node at the start of learning of a new NeRF assigned in S504, S518, and S519.

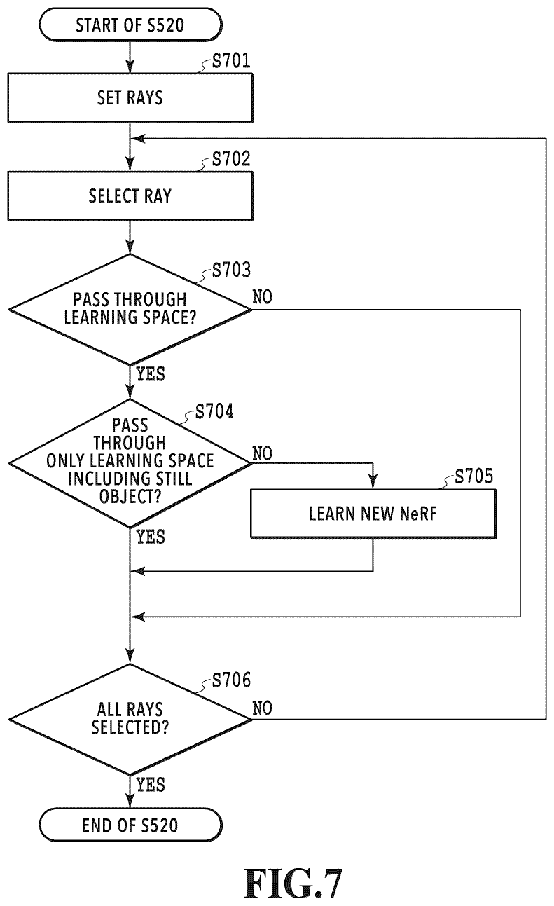

After S518 or S519, in S520, the learning unit 405 performs learning of the new NeRF assigned in S518 or S519. Details of the learning processing by the learning unit 405 will be described later with reference to FIG. 7. As a result of the learning, the feature amount of the learned NeRF corresponding to all of the learning spaces set in S512 is obtained. After the learning processing by the learning unit 405 in S520, in S521, the generating unit 409 generates a virtual viewpoint image. Specifically, the generating unit 409 generates a virtual viewpoint image based on the feature amount of the learned NeRF obtained as a result of the learning processing in S520 or, in other words, the estimated radiance field and the virtual camera path obtained in S500. As a generation method of the virtual viewpoint image, the method of volume rendering described above in the description of S505 may be used.

After S521, the image processing apparatus 102 ends the processing of the flow chart shown in FIG. 5. Subsequently, every time a captured image constituting a new new frame is output from each image capturing apparatus 101, the image processing apparatus 102 repetitively executes processing from S511 to S521 shown in the flow chart in FIG. 5. In addition, every time a captured image constituting a new reference frame is output from each image capturing apparatus 101, the image processing apparatus 102 repetitively executes processing from S500 to S521 shown in the flow chart in FIG. 5. In this case, if there is no addition of or change to the virtual camera path, the image processing apparatus 102 may omit the processing of S500. If there is no change to the image capturing parameters in all of the image capturing apparatuses 101, the image processing apparatus 102 may also omit the processing of S501.

While the generating unit 409 has been described as generating a virtual viewpoint image in S521 based on the result of the learning processing in S520 and a virtual camera path in the present embodiment, the generation method of a virtual viewpoint image in S521 is not limited thereto. For example, the image processing apparatus 102 may generate a virtual viewpoint image in S521 as follows. Specifically, first, in the generation processing of a virtual viewpoint image in S507, the image processing apparatus 102 outputs a feature amount for each learning space calculated for each ray or, in other words, a value of a pixel corresponding to each ray obtained by volume rendering and causes the storage apparatus 104 or the like to store the value. Next, in the generation processing of a virtual viewpoint image in S521, first, the image processing apparatus 102 obtains the feature amount stored in the storage apparatus 104 or the like regarding the learning space judged to include a still object. In the generation processing, next, the image processing apparatus 102 generates a virtual viewpoint image using the obtained feature amount and a feature amount obtained by performing volume rendering on the learned NeRF corresponding to the learning space including a moving object or, in other words, pixel values.

### Learning Processing in Learning Unit

FIG. 7 is a flow chart which shows an example of a flow of learning processing by the learning unit 405 according to embodiment 1 and which shows an example of a processing flow in S520. The flow chart shown in FIG. 7 is executed after S518 or S519. First, in S701, the learning unit 405 sets a plurality of rays emitted in a direction toward each pixel in a captured image from an image capturing position. Next, in S702, the learning unit 405 selects an arbitrary ray from the plurality of rays set in S701.

Next, in S703, the learning unit 405 judges whether or not the ray selected in S702 (hereinafter, referred to as a “selected ray”) passes through each learning space set in S512. In a case where it is judged in S703 that the selected ray does not pass through one or more learning spaces, the learning unit 405 executes processing of S706 to be described later. In a case where it is judged in S703 that the selected ray passes through one or more learning spaces, the learning unit 405 specifies in the judgment which learning spaces the selected ray passes through and in what order. Information regarding the learning spaces that the specified selected ray passes through and an order of passage is temporarily stored in, for example, the main memory 202 as a result of the passage judgment processing.

In a case where it is judged in S703 that the selected ray passes through one or more learning spaces, the learning unit 405 executes processing of S704. In this case, in S704, the learning unit 405 judges whether or not the selected ray only passes through learning spaces that include a still object based on the result of passage judgment processing in S703 and a judgment result of learning spaces output from the judging unit 404 in S514 or S515. In a case where it is judged in S704 that the selected ray only passes through learning spaces that include a still object, the learning unit 405 executes processing of S706 to be described later.

In a case where it is judged in S704 that the selected ray does not only pass through learning spaces that include a still object or, in other words, the selected ray passes through a learning space at least including a moving object, the learning unit 405 executes processing of S705. Next, in S705, the learning unit 405 performs learning of the new NeRF assigned to the learning space in S518 or S519. Here, in a case where the selected ray passes through the learning space including the still object and the learning space including the moving object, the learning unit 405 performs learning of the new NeRF assigned to the learning space in S518 using the feature amount assigned to the learning space in S517.

In this manner, in the estimation of a radiance field based on a new frame, the estimation result of the radiance field based on a reference frame is appropriated with respect to a learning space including a still object and only learning of the NeRF assigned to a learning space containing a moving object is performed. Therefore, due to such learning, the amount of computations related to learning of a NeRF in a case of estimating a radiance field based on a new frame may be reduced. Note that in a case where it is judged in S704 that the selected ray only passes through learning spaces that include a still object, since the estimation result of a radiance field based on the reference frame is already appropriated for the learning spaces, processing of S705 is omitted. After S705, the learning unit 405 executes processing of $706.

In S706, the learning unit 405 judges whether or not all of the rays set in S701 have been selected in S702. In a case where it is judged in S706 that at least a part of all of the rays have not yet been selected, the learning unit 405 returns to the processing of S702 and repetitively executes the processing from S702 to S706 until it is judged that all of the rays have been selected in S706. Note that in the repetitive processing, in S702, for example, the learning unit 405 selects an arbitrary ray from one or more rays that have not yet been selected among all of the rays. In a case where it is judged in S706 that all of the rays have been selected, the learning unit 405 ends the processing of the flow chart shown in FIG. 7 or, in other words, the processing shown in S520 in FIG. 5.

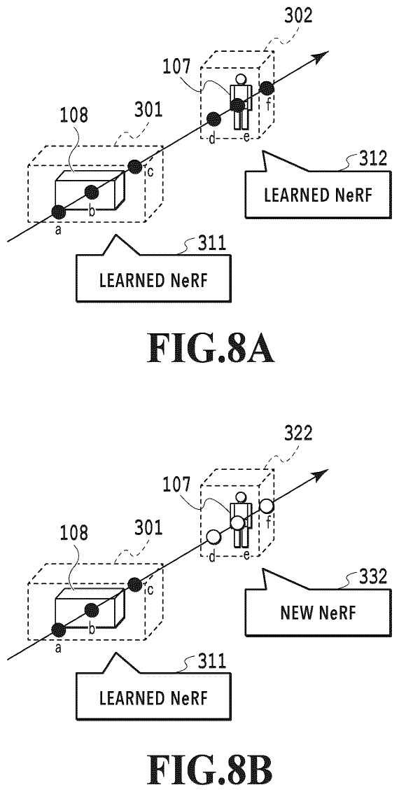

FIGS. 8A and 8B are diagrams for describing an example of learning processing by the learning unit 405 according to embodiment 1 and are diagrams for describing an example of processing of S706 shown in the flow chart in FIG. 7. Referring to FIGS. 8A and 8B, a case will be described in which, in learning of a NeRF based on a new frame, a weight parameter of a learned NeRF obtained as a result of learning based on a reference frame is assigned to a learning space including a still object. In FIGS. 8A and 8B, the learning space 301 includes the object 108 that is a still object and the learning space 302 and the learning space 322 include the object 107 that is a moving object.

FIG. 8A shows, as an example of a result of learning processing based on the reference frame in S505 shown in FIG. 5, the learned NeRF 311 that is a learning result related to the learning space 301 and the learned NeRF 312 that is a learning result related to the learning space 302. In addition, FIG. 8B shows the learned NeRF 311 as a feature amount to be assigned to the learning space 301 in S517 in FIG. 5 and the new NeRF 332 to be assigned to the learning space 322 in S518. Note that in FIGS. 8A and 8B, a black circle indicates a sampling point at which learning with respect to color and density has been completed and a white circle indicates a sampling point at which learning with respect to color and density has not been performed.

In learning based on a new frame, first, the new NeRF 332 is assigned by the setting unit 403 in S518 to the learning space 322 that includes a moving object. In addition, the learned NeRF 311 obtained as a result of learning based on a reference frame is assigned by the setting unit 403 in S517 to the learning space 301 that includes a still object. Next, the color and the density of the sampling points a, b, and c of the learning space 301 are calculated using the learned NeRF 311 obtained as a result of learning based on a reference frame. Next, the color and the density of the sampling points d, e, and f of the learning space 322 are calculated using the new NeRF 332.

Next, by performing volume rendering by integrating the colors and densities calculated at the sampling points a, b, c, d, e, and f, a value of a pixel (pixel value) corresponding to a ray that passes through the sampling points is calculated. Finally, the weight of the NeRF 332 is updated by feeding back an error between the value of the pixel and a value of a pixel corresponding to the pixel in a captured image to the NeRF 332 while retaining the weight of the learned NeRF 311. As described above, in learning based on a new frame, the learning unit 405 performs learning that appropriates the weight parameter of the learned NeRF 311 obtained as a result of learning based on the reference frame.

Next, a case will be described in which, in learning based on a new frame, values of the color and the density of a learned sampling point obtained as a result of learning based on a reference frame is assigned as a feature amount to a learning space including a still object. In learning based on the new frame, first, the new NeRF 332 is assigned by the setting unit 403 in S518 to the learning space 322 that includes a moving object.

In addition, learned values of the color and the density obtained as a result of learning based on a reference frame are assigned by the setting unit 403 in S518 as the feature amount to the colors and the densities of the sampling points a, b, and c of the learning space 301 including a still object.

In addition, in S518, the setting unit 403 assigns the learned color and density values obtained as a result of learning based on the reference frame as features to the color and density of sampling points a, b, and c in the learning space 301 that includes a still object.

Next, the colors and the densities of the sampling points d, e, and f of the learning space 322 that includes a moving object are calculated using the new NeRF 332. Next, by performing volume rendering by integrating the colors and densities of the sampling points a, b, c, d, e, and f, a value of a pixel (pixel value) corresponding to a ray that passes through the sampling points is calculated. Finally, the weight parameter of the NeRF 332 is updated by feeding back an error between the value of the pixel and a value of a pixel corresponding to the pixel in a captured image to the NeRF 332. As described above, in learning based on a new frame, the learning unit 405 may also perform learning that appropriates the learned color and density obtained as a result of learning based on the reference frame.

Finally, a case will be described in which, in learning based on a new frame, an integrated value of the color and the density of a learned sampling point obtained as a result of learning based on a reference frame is assigned as a feature amount to a learning space including a still object. In learning based on the new frame, first, the new NeRF 332 is assigned by the setting unit 403 in S518 to the learning space 322 that includes a moving object. In addition, as the integrated value of the colors and the densities of the sampling points a, b, and c of the learning space 301 including a still object, an integrated value of the learned colors and the learned densities obtained as a result of learning based on a reference frame are assigned by the setting unit 403 in S518.

Next, the colors and the densities of the sampling points d, e, and f of the learning space 322 that includes a moving object are calculated using the new NeRF 332. Next, volume rendering is performed by integrating the colors and densities of the sampling points d, e, and f in a state where an integrated value of the learned colors and the learned densities obtained as a result of learning based on a reference frame are assigned as the integrated value of the colors and the densities of the sampling points a, b, and c. Due to the volume rendering, a value of a pixel corresponding to a ray that passes through the sampling points a, b, c, d, e, and f is calculated. Finally, the weight of the NeRF 332 is updated by feeding back an error between the value of the pixel and a value of a pixel corresponding to the pixel in a captured image to the NeRF 332. As described above, in learning based on a new frame, the learning unit 405 may also perform learning that appropriates an integrated value of the learned color and density obtained as a result of learning based on the reference frame.

While the description given above assumes that one type of a feature amount is assigned as a feature amount related to a learned NeRF to a learning space including a still object, two or more types of feature amounts may be assigned to the space. Specifically, for example, the setting unit 403 may assign a feature amount indicating values of a learned color and a learned density of each sampling point and a feature amount indicating an integrated value of the learned color and the learned density to a learning space including a still object.

For example, there are cases where a front-back relationship of positions of the still object and the moving object changes with respect to the image capturing position. In a case where the still object is closer to the image capturing position than the moving object, first, the learning unit 405 refers to a feature amount indicating an integrated value of learned density in the feature amount assigned to the learning space including a still object corresponding to each ray. In a case where the integrated value of learned density corresponding to a given ray is equal to or higher than a given threshold or, in other words, in a case where the still object is not transparent or translucent on a path through which the ray passes, the learning unit 405 omits learning of the ray in a learning space including a moving object. This is because the learning space including the moving object is occluded by the still object in a case of looking from the image capturing position in a direction in which the ray travels.

In addition, in a case where the moving object is closer to the image capturing position than the still object, first, the learning unit 405 calculates an integrated value of the density of the learning space including a moving object corresponding to each ray. In a case where the integrated value corresponding to a given ray is equal to or higher than a given threshold or, in other words, in a case where the moving object is not transparent or translucent on a path through which the ray passes, the learning unit 405 performs volume rendering with respect to only a learning space including a moving object. This is because the learning space including the still object is occluded by the moving object in a case of looking from the image capturing position in a direction in which the ray travels. Next, the learning unit 405 feeds back an error between the value of the pixel calculated by the volume rendering and a value of a pixel corresponding to the pixel in a captured image to the NeRF 332.

On the other hand, in a case where the integrated value of the density of a learning space including a moving object corresponding to a given ray is lower than the threshold, the learning unit 405 calculates a sum of the integrated value of the density of the learning space including a moving object and an integrated value of the density of a learning space including a still object. In this case, in a case where the sum is less than a given threshold, the learning unit 405 calculates integrated values of the color and the density of a learning space including a moving object and calculates a sum of the integrated values and integrated values of the color and the density assigned to the learning space including a still object. Next, the learning unit 405 feeds back an error between the value of the sum and a pixel value of the captured image to the NeRF 332.

In a case where the sum of the integrated value of the density of the learning space including a moving object and the integrated value of the density of the learning space including a still object is equal to or larger than a threshold, the learning unit 405 executes the processing described below. In this case, first, the learning unit 405 calculates integrated values of the color and the density of the learning space including the moving object. Next, with respect to the integrated values, the learning unit 405 integrates the color and the density of sampling points in the learning space including the still object in an order of proximity to the learning space including the moving object so that the integrated value of the density equals or exceeds a threshold. Next, the learning unit 405 feeds back an error between the pixel value obtained by the integration and a pixel value of the captured image to the NeRF 332.

### Effect Produced by Image Processing Apparatus

As described above, in the present embodiment, the image processing apparatus 102 is configured to specify a learning space including a still object in a scene based on a reference frame and a new frame. In addition, in the present embodiment, in the estimation of a three-dimensional field based on the new frame, the image processing apparatus 102 is configured to appropriate an estimation result of a three-dimensional field estimated based on the reference frame with respect to a learning space including a still object. According to the image processing apparatus 102 configured as described above, in the estimation of a three-dimensional field based on the new frame, an amount of computations required for learning of a three-dimensional field model for the estimation may be reduced.

### Embodiment 2

In embodiment 1, an aspect was described in which a still space in a scene is specified based on a reference frame and a new frame and a learning result of a NeRF based on the reference frame is appropriated with respect to the still space in an estimation of a three-dimensional field (radiance field) based on the new frame. In embodiment 2, an aspect will be described in which, instead of an estimation of a three-dimensional field using a three-dimensional field model such as a NeRF as in embodiment 1, an estimation of a three-dimensional field is performed by grid-based learning such as that described in “Plenoxels: Radiance Fields without Neural Networks” (hereinafter, referred to as “document 1”). Note that since a configuration of an image capturing system and a configuration of an image processing apparatus according to embodiment 2 are similar to those in embodiment 1, hereinafter, same components will be described using the codes denoted in FIG. 1, 2, or 4.

In grid-based learning of a three-dimensional field, a three-dimensional field corresponding to a three-dimensional space is reproduced by dividing the three-dimensional space by equally spaced voxel grids and assigning a feature amount to each grid point of the voxel grids. Here, the feature amount to be assigned to each grid point is, for example, a value related to a color and a density at the grid point. Details of grid-based learning of a three-dimensional field are described in document 1 mentioned above.

### Operation of Image Processing Apparatus

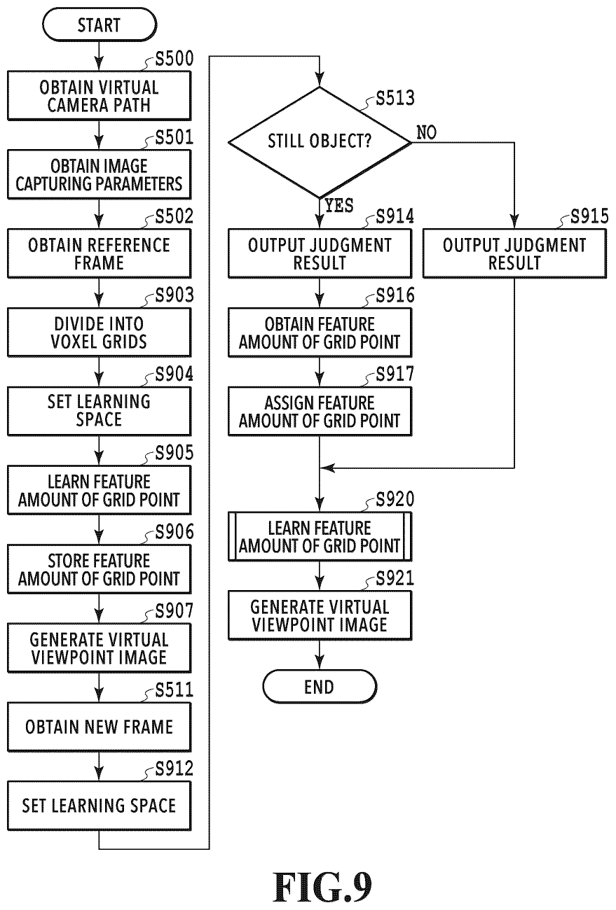

FIG. 9 is a flow chart showing an example of a processing flow of the image processing apparatus 102 according to embodiment 2 (hereinafter, simply represented as “image processing apparatus 102”). The series of processing steps shown in the flow chart in FIG. 9 is realized by the CPU 201 reading a predetermined program from the storage device 203, deploying the program on the main memory 202, and executing the program. Note that in the following description, the processing steps similar to those in the flow chart in FIG. 5 will be denoted by the same codes and the description thereof will be omitted.

First, the image processing apparatus 102 executes processing from S500 to S502. After S502, in S903, the setting unit 403 divides the image capturing space 106 by equally spaced voxel grids. Next, in S904, based on the image capturing parameters obtained in S501 and the reference frame obtained in S502, the setting unit 403 sets a space including an object among the plurality of voxel grids divided in S903 as a learning space for each object. For example, the setting unit 403 estimates a three-dimensional shape of the object according to the VH method or the like described earlier based on the image capturing parameters and the reference frame and sets a voxel grid included in a space corresponding to a rectangular parallelopiped that circumscribes a three-dimensional shape of the estimated object as a learning space.

Next, in S905, using the image capturing parameters obtained in S501 and the reference frame obtained in S502, the learning unit 405 performs learning with respect to a feature amount of each grid point of the voxel grid included in the learning space set in S904. In the learning of a feature amount of a grid point of a voxel grid, a difference between a pixel value obtained as a result of volume rendering and a pixel value of a captured image is fed back in a similar manner to the learning in the learning unit 405 according to embodiment 1.

As procedures for performing volume rendering in grid-based learning of a three-dimensional field, first, a ray corresponding to a direction from an image capturing position to each pixel in a captured image is set. Next, a plurality of sampling points are set on each set ray and a color and a density of each sampling point are calculated using a color and a density of a grid point of a voxel grid existing in a vicinity of the sampling point. A feature amount of a sampling point may be calculated by, for example, subjecting feature amounts of grid points corresponding to eight vertexes constituting a voxel including the sampling point to tri-linear interpolation. A calculation method of a feature amount of a sampling point is not limited thereto. For example, a feature amount related to a color of a sampling point may be calculated using a feature amount of a color directly assigned to each grid point or calculated by assigning a coefficient of a spherical harmonic function to each grid point and further inputting a coefficient subjected to tri-linear interpolation to the spherical harmonic function.

Next, an image according to volume rendering is generated by integrating calculated values of the color and the density of the respective sampling points. The learning unit 405 performs learning of the feature amount of each grid point by updating the feature amount of each grid point so that a difference between the image generated in this manner and a captured image as correct answer data decreases.

After the learning processing of the feature amount of each grid point in S905 ends, the feature amount output unit 406 executes processing of S906. In S906, the feature amount output unit 406 outputs a feature amount of a grid point included in the learning space set in S904 among the feature amounts of the grid points obtained as a result of the learning processing in S905 to the storage apparatus 104 or the like and causes the storage apparatus 104 or the like to store the feature amount. Here, an end condition of the learning processing of the feature amount of each grid point in S905 is, for example, in a case where a difference between a captured image as correct answer data and an image generated by volume rendering corresponding to the captured image becomes smaller than a given threshold. Note that the end condition is not limited thereto and, for example, the end condition may be in a case where the number of performances of supervised learning using each captured image as correct answer data reaches a given number of performances, in a case where learning processing has been performed over a given period, or the like.

After S906, in S907, the generating unit 409 generates a virtual viewpoint image based on a learned feature amount of each grid point corresponding to each learning space obtained as a result of the learning processing in S905 and the virtual camera path obtained in S500. As a generation method of the virtual viewpoint image, the method of volume rendering described above in the description of S905 may be used. After S907, the image processing apparatus 102 executes processing of S511. After S511, in S912, based on the image capturing parameters obtained in S501 and the new frame obtained in S511, the setting unit 403 sets a space including an object among the plurality of voxel grids divided in S903 as a learning space. Since the processing in S912 is similar to the setting processing of the learning space based on the image capturing parameters and the reference frame in S904, a description will be omitted. Note that “0” or a random value generated by a random number generator or the like is given as an initial value to the feature amount of each grid point included in the learning space set in S904 and S912. After S912, the image processing apparatus 102 executes processing of S513.

In a case where it is judged in S513 that an object included in the learning space is a still object, the judging unit 404 executes processing of S914. In this case, in S914, the judging unit 404 outputs information indicating that the feature amount of the grid point stored in the storage apparatus 104 or the like is to be used for the learning space to the learning unit 405, the setting unit 403, and the feature amount obtaining unit 407 as a judgment result of the learning space. In a case where it is judged in S513 that the object included in the learning space is not a still object or, in other words, the object is a moving object, the judging unit 404 executes processing of S915. In this case, in S915, the judging unit 404 outputs information indicating that learning is to be newly performed with respect to the feature amount of the grid point without using the feature amount of the grid point stored in the storage apparatus 104 or the like for the learning space to the learning unit 405 and the setting unit 403 as a judgment result of the learning space.

After S914, in S916, the feature amount obtaining unit 407 obtains a feature amount of each grid point included in the learning space judged to include a still object in S513 from the storage apparatus 104 or the like. Next, in S917, the setting unit 403 assigns the feature amount of each grid point obtained in S916 or, in other words, values of the color and the density of each grid point to the learning space judged to include a still object in S513. This is because the feature amount of each grid point included in the learning space including the still object has already been learned based on the reference frame and there is no need to newly learn the feature amount of each grid point included in the learning space including the still object.

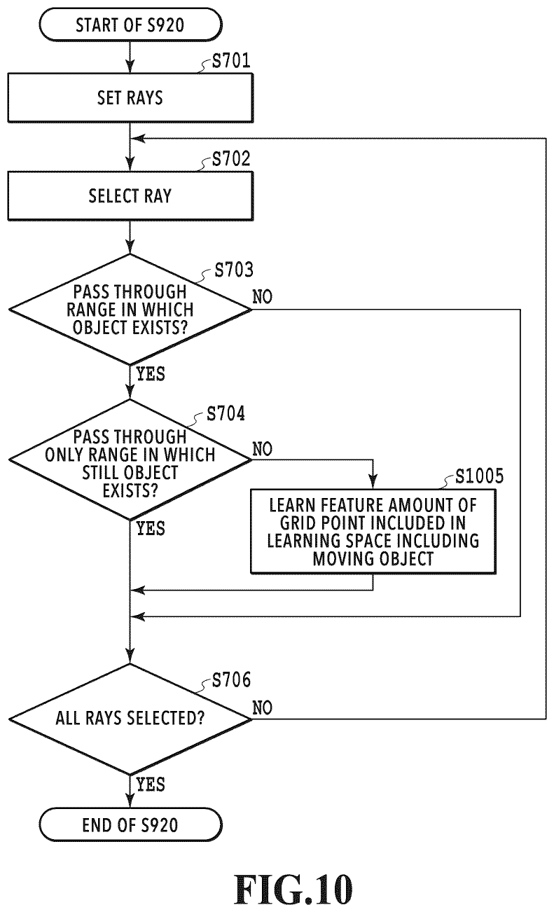

After S917 or S915, in S920, the learning unit 405 performs learning of the feature amount of each grid point included in the learning space set in S912. Details of the learning processing by the learning unit 405 will be described later with reference to FIG. 10. As a result of the learning, a learned feature amount is obtained with respect to each grid point included in all of the learning spaces set in S512. After the learning processing by the learning unit 405 in S920, in S921, the generating unit 409 generates a virtual viewpoint image. Specifically, the generating unit 409 generates a virtual viewpoint image based on the learned feature amount of each grid point obtained as a result of the learning processing in S920 or, in other words, the estimated three-dimensional field and the virtual camera path obtained in S500. As a generation method of the virtual viewpoint image, the method of volume rendering described above in the description of S905 may be used.

After S921, the image processing apparatus 102 ends the processing of the flow chart shown in FIG. 9. Subsequently, every time a captured image constituting a new new frame is output from each image capturing apparatus 101, the image processing apparatus 102 repetitively executes processing from S511 to S921 shown in the flow chart in FIG. 9. In addition, every time a captured image constituting a new reference frame is output from each image capturing apparatus 101, the image processing apparatus 102 repetitively executes processing from S500 to S921 shown in the flow chart in FIG. 9. In this case, if there is no addition of or change to the virtual camera path, the image processing apparatus 102 may omit the processing of S500. If there is no change to the image capturing parameters in all of the image capturing apparatuses 101, the image processing apparatus 102 may also omit the processing of S501.

### Learning Processing in Learning Unit

FIG. 10 is a flow chart which shows an example of a flow of learning processing by the learning unit 405 according to embodiment 2 and which shows an example of a processing flow in S920. The flow chart shown in FIG. 10 is executed after S917 or S915. Note that in the following description, the processing steps similar to those shown in the flow chart in FIG. 7 will be denoted by the same codes and the description thereof will be omitted. First, the learning unit 405 executes processing of S701 to S703. In a case where it is judged in S703 that the selected ray does not pass through one or more learning spaces, the learning unit 405 executes processing of S706. In a case where it is judged in S703 that the selected ray passes through one or more learning spaces, the learning unit 405 specifies in the judgment which learning spaces the selected ray passes through and in what order. Information regarding the learning spaces that the specified selected ray passes through and an order of passage is temporarily stored in, for example, the main memory 202 as a result of the passage judgment processing.

In a case where it is judged in S703 that the selected ray passes through one or more learning spaces, the learning unit 405 executes processing of $704. In a case where it is judged in S704 that the selected ray only passes through learning spaces that include a still object, the learning unit 405 executes processing of S706. In a case where it is judged in S704 that the selected ray does not only pass through learning spaces that include a still object or, in other words, the selected ray passes through a learning space at least including a moving object, the learning unit 405 executes processing of S1005. In S1005, the learning unit 405 performs learning of the feature amount of each grid point included in the learning space judged to include a moving object in S513 among the respective grid points included in the learning space set in S512. Here, in a case where the selected ray passes through the learning space including the still object and the learning space including the moving object, the learning unit 405 uses the feature amount of each grid point assigned in S917 in the learning.

In this case, first, the learning unit 405 calculates the color and the density of sampling points of the learning space judged to include a still object in S513 using a learned feature amount of each grid point included in the learning space obtained as a result of learning based on the reference frame. Next, the learning unit 405 calculates the color and the density of sampling points of the learning space judged to include a moving object in S513 using a feature amount of the grid points included in the learning space. Next, the learning unit 405 performs volume rendering by integrating the calculated colors and densities of the respective sampling points and calculates a value of a pixel (pixel value) corresponding to the selected ray.

Next, the learning unit 405 feeds back an error between the value of the pixel (pixel value) obtained in the volume rendering and a value of a pixel (pixel value) corresponding to the pixel in a captured image to the learning space judged to include a moving object in S513. By performing the feedback, the learning unit 405 updates the feature amount of each grid point included in the learning space judged to include a moving object in S513 while fixing the feature amount of each grid point included in the learning space judged to include a still object in S513. After S1005, the learning unit 405 executes processing of S706.

In a case where it is judged in S706 that at least a part of all of the rays have not yet been selected, the learning unit 405 returns to the processing of S702 and repetitively executes the processing from S702 to S706 until it is judged that all of the rays have been selected in S706. Note that in the repetitive processing, in S702, for example, the learning unit 405 selects an arbitrary ray from one or more rays that have not yet been selected among all of the rays. In a case where it is judged in S706 that all of the rays have been selected, the learning unit 405 ends the processing of the flow chart shown in FIG. 10 or, in other words, the processing shown in S920 in FIG. 9.

### Effect Produced by Image Processing Apparatus

As described above, in the present embodiment, the image processing apparatus 102 is configured to specify a learning space including a still object in a scene based on a reference frame and a new frame. In addition, in the estimation of a three-dimensional field based on the new frame, with respect to a learning space including the still object, the image processing apparatus 102 is configured to appropriate a feature amount of a grid point obtained as a result of learning based on the reference frame or, in other words, an estimation result of a three-dimensional field based on the reference frame. According to the image processing apparatus 102 configured as described above, in the estimation of a three-dimensional field based on the new frame, an amount of computations required for learning of a three-dimensional field model for the estimation may be reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, an amount of computations required to estimate a three-dimensional field may be reduced.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-120380, filed on Jul. 25, 2024, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining a plurality of captured images obtained by synchronized image capturing of an image capturing space from a plurality of directions;
setting, for each object existing in the image capturing space, a three-dimensional space including the object as a learning space based on the plurality of captured images;
performing learning of, for each of the learning spaces set, a three-dimensional field corresponding to the learning space based on the plurality of captured images; and
in a case of performing learning of the three-dimensional field corresponding to the learning space based on the plurality of captured images obtained by synchronized image capturing at a given time point, with respect to the learning space in which the object included in the learning space is a still object, performing learning of a feature amount of the three-dimensional field corresponding to the learning space including a moving object by using the feature amount of the three-dimensional field already obtained as a result of learning based on the plurality of captured images obtained by synchronized image capturing at another time point as the feature amount of the three-dimensional field corresponding to the learning space.

2. The image processing apparatus according to claim 1, wherein
the feature amount of the three-dimensional field includes values indicating a color and a density corresponding to a position and a direction in the learning space.

3. The image processing apparatus according to claim 2, wherein
the feature amount of the three-dimensional field includes a value indicating transparency or opaqueness corresponding to a position and a direction in the learning space.

4. The image processing apparatus according to claim 1, wherein
the feature amount of the three-dimensional field includes a network parameter of a learning model related to the three-dimensional field corresponding to the learning space.

5. The image processing apparatus according to claim 1, wherein
the feature amount of the three-dimensional field includes an integrated value obtained by performing volume rendering of the three-dimensional field corresponding to the learning space on a predetermined ray.

6. The image processing apparatus according to claim 1, wherein the one or more programs further include instructions for:
estimating the three-dimensional field corresponding to the learning space by performing learning of at least any of a learning model assigned for each of the learning space, a feature amount of a grid point included in each of the learning space, and a function assigned to a grid point included in each of the learning space.

7. The image processing apparatus according to claim 1, wherein the one or more programs further include instructions for:
setting the learning space for each of the object based on a position of the object in the image capturing space.

8. The image processing apparatus according to claim 1, wherein the one or more programs further include instructions for:
performing a judgment on whether or not the still object is included in the learning space; and
performing learning of the feature amount of the three-dimensional field corresponding to the learning space based on a result of the judgment.

9. The image processing apparatus according to claim 8, wherein the one or more programs further include instructions for:
performing the judgment based on an optical flow in the plurality of captured images.

10. The image processing apparatus according to claim 8, wherein the one or more programs further include instructions for:
performing the judgment based on a change in a three-dimensional shape of the object obtained based on the plurality of captured images.

11. The image processing apparatus according to claim 1, wherein
the three-dimensional field is a radiance field.

12. The image processing apparatus according to claim 1, wherein the one or more programs further include instructions for:
generating an image corresponding to an appearance from an arbitrary virtual viewpoint based on the three-dimensional field corresponding to the learning space obtained as a result of learning.

13. An image processing method comprising the steps of:
obtaining a plurality of captured images obtained by synchronized image capturing of an image capturing space from a plurality of directions;
setting, for each object existing in the image capturing space, a three-dimensional space including the object as a learning space based on the plurality of captured images;
performing learning of, for each of the learning spaces set, a three-dimensional field corresponding to the learning space based on the plurality of captured images; and
in a case of performing learning of the three-dimensional field corresponding to the learning space based on the plurality of captured images obtained by synchronized image capturing at a given time point, with respect to the learning space in which the object included in the learning space is a still object, performing learning of a feature amount of the three-dimensional field corresponding to the learning space including a moving object by using the feature amount of the three-dimensional field already obtained as a result of learning based on the plurality of captured images obtained by synchronized image capturing at another time point as the feature amount of the three-dimensional field corresponding to the learning space.

14. A non-transitory computer readable storage medium storing a program for causing a computer to perform a control method of controlling an image processing apparatus, the control method comprising the steps of:
obtaining a plurality of captured images obtained by synchronized image capturing of an image capturing space from a plurality of directions;
setting, for each object existing in the image capturing space, a three-dimensional space including the object as a learning space based on the plurality of captured images;
performing learning of, for each of the learning spaces set, a three-dimensional field corresponding to the learning space based on the plurality of captured images; and
in a case of performing learning of the three-dimensional field corresponding to the learning space based on the plurality of captured images obtained by synchronized image capturing at a given time point, with respect to the learning space in which the object included in the learning space is a still object, performing learning of a feature amount of the three-dimensional field corresponding to the learning space including a moving object by using the feature amount of the three-dimensional field already obtained as a result of learning based on the plurality of captured images obtained by synchronized image capturing at another time point as the feature amount of the three-dimensional field corresponding to the learning space.
